(19) United States
(12) Patent Application Publication
(10) Pub. No.: US 2008/0180833 A1
(43) Pub. Date: Jul. 31, 2008

(54) METHOD AND APPARATUS FOR SPACING CONTROL IN A DISK DRIVE

(75) Inventor: Yusuke Ohinata, Hamura-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/954,597

(22) Filed: Dec. 12, 2007

(30) Foreign Application Priority Data
Jan. 31, 2007 (JP) 2007-022067

(51) Int. Cl. G11B 21/02

(52) U.S. Cl. 360/75

(57) ABSTRACT

According to one embodiment, a disk drive includes a head, a shock sensor, and a controller. The head has a heating element for controlling the spacing between a disk medium and the head. When the shock sensor detects an impact applied to the disk drive, the controller controls the heating element, increasing the spacing between the head and the disk medium.

### CROSS-REFERENCE TO RELATED APPLICATIONS

This application is based upon and claims the benefit of priority from Japanese Patent Application No. 2007-022067, filed Jan. 31, 2007, the entire contents of which are incorporated herein by reference.

### BACKGROUND

1. Field

One embodiment of the present invention relates to a disk drive, and more particularly to a technique of controlling the spacing between the head and the disk-shaped medium in the disk drive.

2. Description of the Related Art

In most disk drives, a representative example of which is a hard disk drive, the magnetic head (hereinafter referred to as head) is mounted on the actuator and can read and write data in and from a disk medium while being floated with a very narrow physical space from the surface of the disk medium. This very narrow physical space is called “spacing.”

The flying height of the head, i.e., the spacing between the head and the disk medium, is made as narrow as possible in order to enhance the efficiency of recording and reproducing data in and from the disk medium. Further, the spacing should be sufficient to prevent the head from colliding with the disk medium.

A method of adjusting the spacing between a head and a disk medium has been developed, as disclosed in, for example, Jpn. Pat. Appln. Publication No. 2005-56447. In this conventional method, a heat-generating body is provided in the head. The heat-generating body (heater) heats the head, making the same expand (or protrude), thereby adjusting the spacing. The head comprises a main body called a “slider” and a reading element and a writing element, both mounted on the distal end of the slider. The slider is a member that floats by virtue of the air pressure generated between it and the rotating disk medium that is rotating.

In the conventional method, the heat-generating body provided on the head is controlled by a current supplied from a control circuit connected to a preamplifier circuit. Publication No. 2005-56447 indeed discloses that the heat-generating body is controlled to adjust the spacing, at the time of recording and reproducing data in or from the disk medium. However, the publication proposes no methods related to measures against impacts due to disturbance, though it is important to control the impacts.

Disk drives recently developed have a shock sensor that detects impacts due to disturbance. Thus, if an impact is detected while data is being written in a disk medium, the data-writing is interrupted. Spacing control achieved by using a heater during the data-writing or data-reading is not included in the conventional method described above.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the major components of a disk drive according to a first embodiment of the present invention;

FIG. 2 is a sectional view illustrating the configuration of the head of the first embodiment;

FIG. 3 is a diagram explaining how the spacing is changed when the head is heated in the first embodiment;

FIG. 4 is a flowchart explaining the sequence of controlling the spacing in the first embodiment;

FIG. 5 is a flowchart explaining the sequence of controlling the spacing in a second embodiment of the present invention;

FIGS. 6A and 6B are diagrams explaining how the spacing is changed in the second embodiment; and

FIG. 7 is a flowchart explaining the sequence of controlling the spacing in a third embodiment of the present invention.

### DETAILED DESCRIPTION

Various embodiments according to the invention will be described hereinafter with reference to the accompanying drawings. In general, according to one embodiment of the invention, there is provided a disk drive to take measures against impacts and ultimately to accomplish an effective spacing control during the data-recording.

### First Embodiment

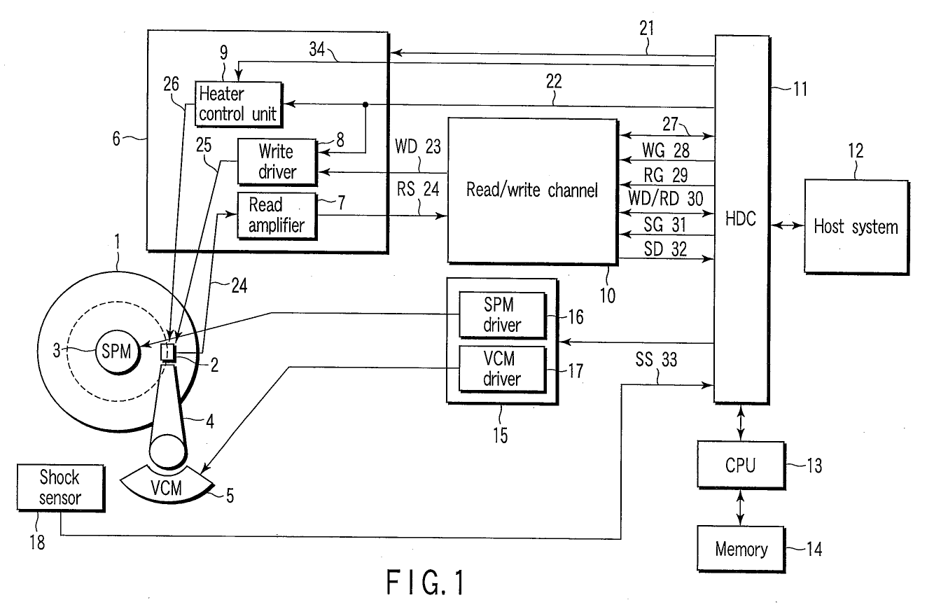

According to an embodiment, FIG. 1 is a block diagram showing the major components of a disk drive.

As shown in FIG. 1, the disk drive has a disk medium 1, a head 2, a spindle motor (SPM) 3, and an actuator 4. The disk medium 1 is a magnetic recording medium. The spindle motor 3 can rotate the disk medium 1. The head 2 is mounted on the actuator 4. The actuator 4 can be rotated to move the head in the radial direction of the disk medium 1. The head 2 includes a reading element and a writing element. The reading element can read (reproduce) data from the medium 1 as will be described later. The writing element can write (record) data in the disk medium 1 as will be described later.

The actuator 4 has an arm (including a suspension), which is the main body and on which the head 2 is held. The actuator 4 can be rotated and controlled by a voice coil motor (VCM) 5. The VCM 5 is driven by a VCM driver 17, which is included in a motor driver 15. The motor driver 15 includes an SPM driver 16. The SPM driver 16 drives and controls the spindle motor 3.

The disk drive has a control/signal-processing system in addition to the head-disk assembly. The control/signal-processing system has a head amplifier unit 6, a read/write channel 10, a disk controller (HDC) 11, a microprocessor (CPU) 13, a memory 14, and the motor driver 15. Recently, some of these circuit components are generally integrated into a single IC chip.

The HDC 11 constitutes an interface between the disk drive and a host system 12 (a personal computer or a digital apparatus). The HDC 11 achieves the transfer of user data to and from the host system 12 during the read/write operation. The HDC 11 controls the read/write operation in a read/write channel 10 via a bidirectional control-signal line (RWC_CTL) 27 that is constituted by a bus interface. Further, the HDC 11 can receive and transmit read/write data 30 (i.e., write data WD and read data RD) of a prescribed format from and to the read/write channel 10, in synchronism with write gate (WG) signal 28 and read gate (RG) signal 29.

The HDC 11 is connected to the head amplifier unit 6 by a bidirectional control-signal line (AMP_CTL) 21 that is constituted by a serial interface. Thus, the HDC 11 can therefore control the read/write operation in the head amplifier unit 6. The HDC 11 outputs a gate signal WG22 to the head amplifier unit 6. The gate signal WG22 is output at the same time as the write gate (WG) signal 28 that represents the timing of data writing.

The read/write channel 10 is a read/write signal processing unit. Upon receiving write gate (WG) signal 28 and the write data (WD) 30 from the HDC 11, the read/write channel 10 transmits, with some delay, write data (WD) 23 of a prescribed format to the write driver 8 of the head amplifier unit 6. At this time, the gate signal WG22 is a gate signal adjusted in timing in accordance with the write data (WD) 23.

The HDC 11 supplies a servo gate (SG) 31, which is a timing signal for achieving servo control (head-position control), to the read/write channel 10. At the timing represented by the servo gate (SG) 31, the read/write channel 10 decodes a reproduced signal (RS) 24 output from a read amplifier 7, generating servo data (SD) 32. The servo data (SD) 32 is output to the HDC 11.

The head amplifier unit 6 includes a read amplifier 7, a write driver 8, and a heater control unit 9. The read amplifier 7 amplifies the reproduced signal (RS) 24 read by the reading element of the head 2. The reproduced signal (RS) 24 thus amplified is output to the read/write channel 10. The write driver 8 outputs a write current signal (WS) 25 to the writing element of the head 2 in response to the gate signal WG22 supplied from the HDC 11.

The heater control unit 9 controls the supply of power to the heating element provided in the head 2, as will be described later. The heater control unit 9 includes a register, in which the enable/disable state of heating control and the power value are registered under the control of a heater control signal 34 output from the HDC 11. In response to the gate signal WG22 input, the heater control unit 9 supplies a heater current (HI) 26 based on the power value set in the register, to the heating element of the head 2.

The heater control unit 9 can set the power value in accordance with whether the gate signal WG22 is at a high (Hi) or low (Low) level. If the gate signal WG22 is at, for example, the high (Hi) level, the heater control unit 9 supplies relatively large power to the heating element, causing the same to generate heat. The heater control unit 9 may stop the supply of power to the heating element in accordance with one or both of the high and low levels of the gate signal WG22.

The heating element can be controlled by a parameter, which is a power value, voltage value or current value. In the first embodiment, the heater control unit 9 performs a control, changing the power supplied to the heating element, in accordance with the gate signal WG22. The power supplied to the heating element may be changed by using, for example, a data enable line, a data input/output line, a data clock line, or a dedicated control signal line, depending upon the configuration of the head amplifier unit 6.

The CPU 13 is the main controller of the disk drive. The CPU 13 controls the positioning of the head 2 (servo control) and the spacing of the head 2. In the servo control, the CPU 13 controls the seeking and the tracking on the basis of servo data SD32 that has been reproduced from the disk medium 1. The CPU 13 is connected to a memory 14, which includes a RAM, a ROM and a flash EEPROM. The memory 14 stores a program for controlling the CPU 13 and various control data items.

The CPU 13 controls the value (i.e., control voltage) to be input to the VCM driver 17 in order to drive the VCM 5. Thus, the CPU 13 controls the VCM driver 17, which in turn drives the actuator 4. The head 2, which is mounted on the actuator 4, is thereby moved to the target position over the disk medium 1.

The disk drive further comprises a shock sensor 18 that is provided either in or on the housing. The shock sensor 18 detects an impact due to disturbance applied to the disk drive from outside. Upon detecting an impact applied to the disk drive due to disturbance and exceeding a preset threshold value, the shock sensor 18 generates a signal. This signal is supplied to the HDC 11 through a signal line (SS) 33.

Then, the HDC 11 supplies a disturbance detection signal to the CPU 13 and outputs a write fault signal to the host system 12. In this case, the HDC 11 sets the write gate (WG) signal to the low level (Low), preventing any unstable signal from being recorded in the disk medium 1 while the disk drive is receiving an impact.

(Structure of the Head)

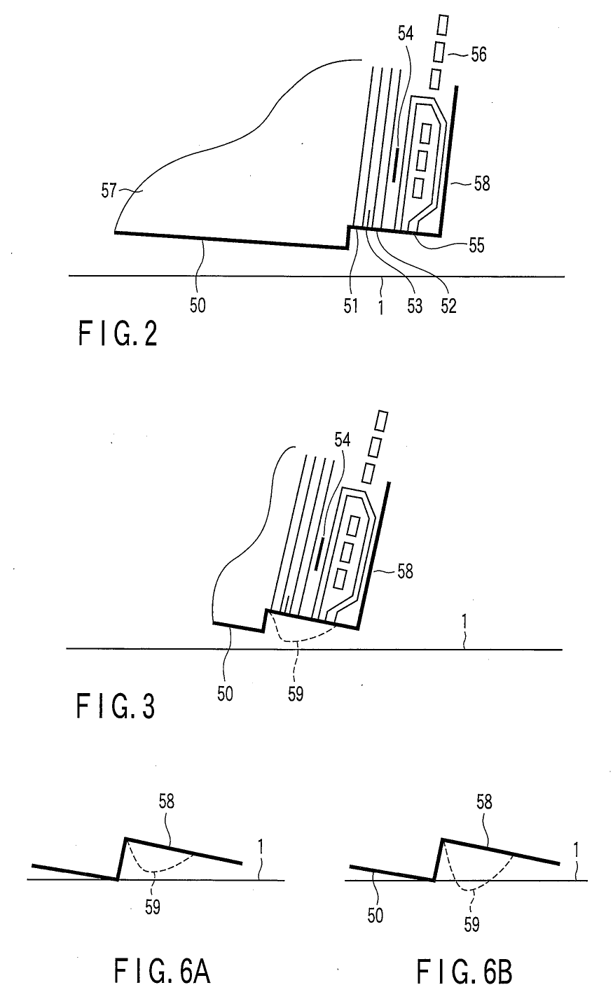

FIG. 2 is a sectional view illustrating the configuration of the head 2 of the present embodiment.

The head 2 has a slider 57 and a head element unit 58. The slider 57 is the main body of the head 2. The head element unit 58 is provided in the distal end of the slider 57. The slider 57 has a counter surface 50 called an “air bearing surface (ABS)” which is opposed to the disk medium 1. The head 2 floats by virtue of the air pressure generated between the counter surface 50 and the rotating disk medium 1.

The head element unit 58 is a little recessed from the counter surface 50, with respect to the surface of the disk medium 1. The head element unit 58 has a lower shield member 51, an upper shield member 52, and a reading element 53. The reading element 53 is an element having a magnetoresistive effect, such as GMR element or TMR element. The lower shield member 51 and upper shield member 52 shield the reading element 53.

The head element unit 58 further has a heating element (heater) 54, a recording magnetic pole (writing element) 55, and a recording coil 56. In this embodiment, the heating element 54 is arranged between the reading element 53 and the writing element 55 as is illustrated in FIG. 2. Nonetheless, the heating element 54 is not limited in position. It may be provided, for example, at the back of the writing element 55, near the recording coil 56, at the back of the lower shield member 51, or at the back of the upper shield member 52.

In this embodiment, the head 2 is a longitudinal magnetic recording head. Instead, it can be a perpendicular magnetic recording head.

FIG. 3 is a diagram explaining how the heating element 54 of the head 2 generates heat when supplied with a current from the heater control unit 9, in order to change the spacing.

As shown in FIG. 3, the magnetic pole 55 of the head element unit 58 expands as the heating element 54 generates heat because of the current supplied to it. As a result, a protrusion 59 develops on the magnetic pole 55, reducing the magnetic spacing (hereinafter referred to as “spacing”), i.e., the space (or distance) between the head element unit 58 and the surface of the disk medium 1.

When the supply of power to the heating element 54 is stopped, the magnetic pole 55 no longer has the protrusion 59. The spacing therefore increases. The spacing is almost proportional to the value of the current (value of power) supplied to the heating element 54.

Assume that the same value of current (or the same value of power) is supplied to the heating element 54 during both the data writing and the data reading. Then, the head element unit 58 generates more heat during the data writing, because the current flowing in the recording coil 56 is converted to heat. In this case, the protrusion 56 is larger, reducing the spacing more, than during the data reading. In practice, the value of current (or the value of power) supplied to the heating element 54 during the data writing or the data reading is adjusted in accordance with the ambient temperature, so that the protrusion 59 may have the same size during the data writing and the data reading.

The space (or distance) between the head element unit 58 and the surface of the disk-shaped medium 1 is also known as the “flying height of the head.” Therefore, the spacing control is equivalent in meaning to flying-height control.

(Spacing Control)

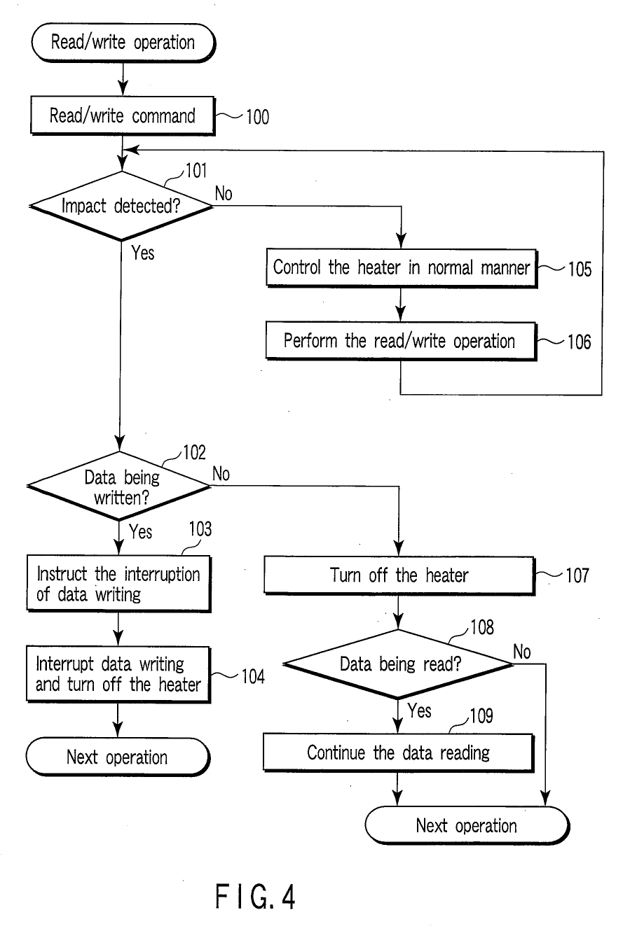

The sequence of the spacing control performed in the first embodiment will be explained with reference to the flowchart of FIG. 4.

First, the disk drive receives a read/write command from the host system 12. In response to this command, the HDC 11 outputs write gate (WG) signal 28 or read gate (RG) signal 29, causing the head 2 to perform data writing or data reading (Block 100).

The CPU 13 determines whether the shock sensor 18 has detected an impact due to a disturbance (Block 101). If the shock sensor 18 has detected an impact (if YES in Block 101), the CPU 13 determines whether the head 2 is performing data writing or is about to perform data writing (Block 102). If the head 2 is performing data writing or is about to perform data writing (if YES in Block 102), the CPU 13 makes the head 2 terminates the data writing (Block 103). Then, the HDC 11 outputs a write fault signal to the host system 12. The HDC 11 set the write gate (WG) signal 28 to low level, terminating the data writing.

At the same time, the HDC 11 outputs a heater control signal 34 in response to an instruction from the CPU 13, stopping the supply of power to the heating element 54 (Block 104).

If the shock sensor 18 has not detected an impact (if NO in Block 101), the power value stored in its register is maintained in the heater control unit 9. Hence, the heating element 54 generates heat, developing a protrusion 59, which spaces the head element unit 58 of the head 2 from the disk medium 1 by the prescribed spacing (Block 105). The HDC 11 causes the head 2 to perform data writing or data reading in the ordinary manner (Block 106).

The head 2 may be performing data reading, not data writing, when the shock sensor 18 has detected an impact due to disturbance (if NO in Block 102, YES in Block 108). If this is the case, the CPU 13 makes the head 2 continue the data reading (Block 109). Note that the HDC 11 outputs a heater control signal 34 in response to an instruction (for disabling the heating control) from the CPU 13, stopping the supply of power to the heating element 54 (Block 107).

Thus, in the first embodiment, the data writing is interrupted, and the supply of power to the heating element 54 (heater) is stopped, if the disk drive receives an impact while the head 2 is writing data. This prevents erroneous data writing in the disk medium 1 at a part other than the designated part due to the impact applied to the disk drive. Since the protrusion 59 (shown in FIG. 3) is reduced in size when the supply of power to the heating element 54 is stopped, the head element unit 58 will not collide with the surface of the disk medium 1.

Moreover, in this embodiment, data reading is performed or continued even if the disk drive receives an impact immediately before the disk drive starts the data reading or while the disk drive is performing the data reading. Even if a read error occurs due to the impact during the data reading, the data reading need not be interrupted in order to perform a retry operation. Nonetheless, the supply of power to the heating element 54 (heater) is stopped, reducing the protrusion 59 in size and thus preventing the head element unit 58 from colliding with the surface of the disk medium 1.

Even if the disk drive receives an impact, the positioning of the head is continued while the data writing is not being performed. In the head positioning, servo data is read from the disk medium 1. Hence, the data reading need not be interrupted since a retry operation can be performed, even if a read error occurs. Further, the head element unit 58 can be prevented from colliding with the surface of the disk medium 1, because the protrusion 59 is reduced in size by stopping the supply of power to the heating element 54 (heater).

### Second Embodiment

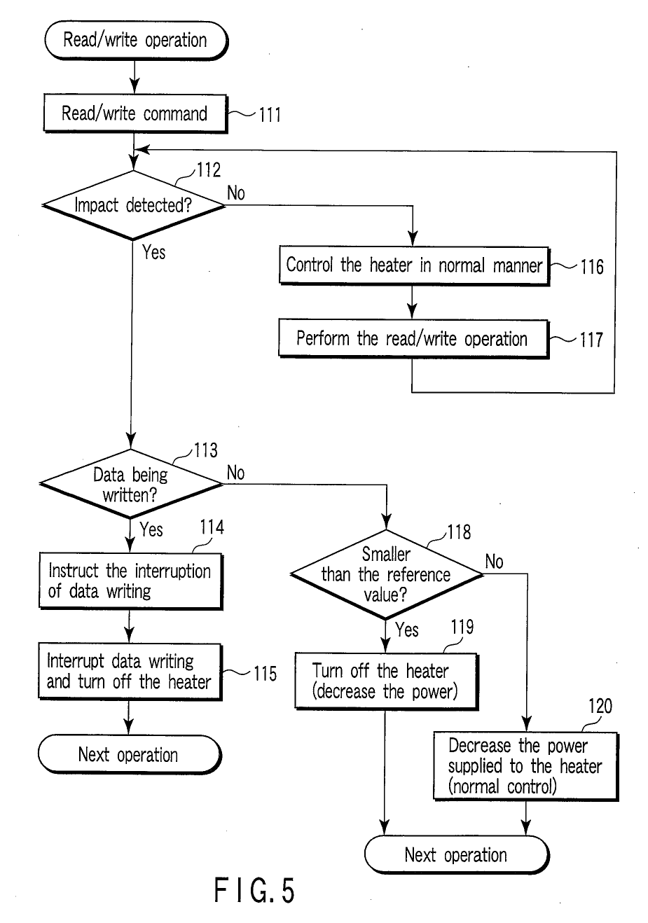

FIG. 5 is a flowchart explaining the sequence of controlling the spacing in a second embodiment of the present invention. The second embodiment is identical to the first embodiment in terms of the configuration of the disk drive and the structure of the head 2. Therefore, the components identical to those shown in FIGS. 1 and 2 will not be described.

As shown in FIG. 6A, a reference value of spacing is inferred from the size of the protrusion 59 that develops when the heating element 54 generates heat. The protrusion 59 may extend beyond the lowest position for the counter surface 50 of the slider 57, as is illustrated in FIG. 6B. In this case, the spacing is smaller than the reference value. This state may result if the heating element 54 is so positioned during the manufacture of the disk drive that a spacing smaller than the reference value is ensured when the heating element 54 generates heat, thus making the head element unit 58 approach the disk medium 1 if the head 2 has a relatively large flying height. The second embodiment is concerned with a control performed if the spacing is smaller than the reference value. How this control is accomplished will be explained with reference to the flowchart of FIG. 5.

The process of Blocks 111 to 115 is identical to the process of Blocks 100 to 104 shown in FIG. 4. Further, the process of Blocks 111, 112, 116 and 117 is identical to the process of Blocks 100, 101, 105 and 106 illustrated in FIG. 4.

In the second embodiment, the CPU 13 makes the head 2 keep performing data reading, not data writing (if NO in Block 113), when the shock sensor 18 detects an impact. The CPU 13 then determines whether the spacing is smaller than the reference value (Block 118).

As long as the disk drive operates in a normal condition, the register provided in the heater control unit 9 stores the value of power (i.e., value of current for generating heat), which determines the spacing. Hence, on the basis of the value of power, stored in the register, the CPU 13 determines whether the spacing is the reference value shown in FIG. 6A or is smaller than the reference value shown in FIG. 6B.

If the spacing is smaller than the reference value shown in FIG. 6B (if YES in Block 118), the HDC 11 outputs a heater control signal 34 in response to an instruction from the CPU 13, disabling the heating control and stopping the supply of power to the heating element 54 (Block 119). Thus, the protrusion 59 is reduced in size, ensuring the spacing equal to or larger than the reference value. The head element unit 58 can therefore be prevented from colliding with the surface of the disk medium 1.

The supply of power to the heating element 54 may also not be stopped. Instead, the power supplied may be decreased in order to change the spacing back to the reference value shown in FIG. 6A. This is because the data signal reproduced by the head 2 will change very much if the spacing is larger than the reference value, inevitably disabling stable data reading. If the data reading is unstable, in reproducing, for example, the servo data for controlling the positioning of the head 2, the head 2 cannot be positioned as is desired.

If the spacing is equal to or larger than the reference value (if NO in Block 118), the HDC 11 outputs a heater control signal 34 in response to an instruction from the CPU 13, decreasing the value of power supplied to the heating element 54 (Block 120). Nevertheless, it is not absolutely necessary to change the value of power supplied to the heating element 54 (in the ordinary control). It is desirable to provide the spacing equal to or larger than the reference value, thereby to prevent the head element unit 58 from colliding with the surface of the disk medium 1.

### Third Embodiment

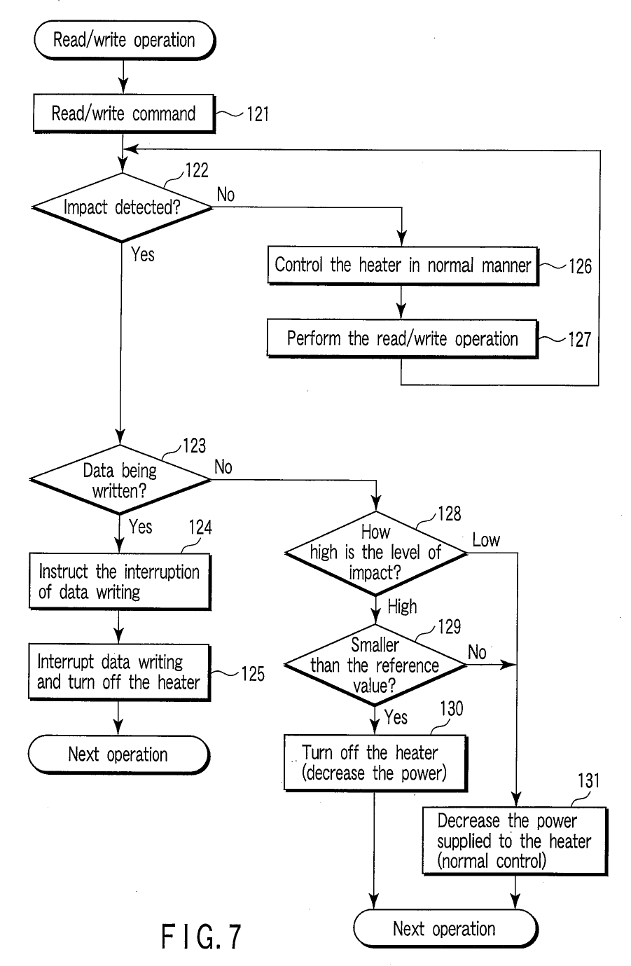

FIG. 7 is a flowchart explaining the sequence of controlling the spacing in a third embodiment of the present invention. The third embodiment is identical to the first embodiment in the configuration of the disk drive and the structure of the head 2. Hence, the components identical to those shown in FIGS. 1 and 2 will not be described.

The third embodiment is concerned with a spacing control in which the heating element 54 is controlled in accordance with the level of the impact detected by the shock sensor 18. How this control is carried out will be explained with reference to the flowchart of FIG. 7.

The process of Blocks 121 to 125 is identical to the process of Blocks 100 to 104 shown in FIG. 4. Further, the process of Blocks 121, 122, 126 and 127 is identical to the process of Blocks 100, 101, 105 and 106 illustrated in FIG. 4.

In the third embodiment, the CPU 13 makes the head 2 keep performing data reading, not data writing, when the shock sensor 18 detects an impact. The CPU 13 then determines whether the impact is greater or smaller than a value preset for the shock sensor 18 (Block 128). If the impact is smaller than the value preset in the sensor 18, the CPU 13 decreases the power supplied to the heating element 54 (Block 131). The value preset for the shock sensor 18 can be changed as long as the disk drive operates in a normal condition.

If the impact is greater than the prescribed value, the CPU 13 makes the head 2 continue the data reading and then determines whether the spacing is smaller than the reference value (Block 129). If the spacing is smaller than the reference value (if YES in Block 129), the CPU 13 outputs an instruction to the HDC 11. In response to the instruction, the HDC 11 outputs a heater control signal 34, stopping the supply of power to the heating element 54 (Block 130). Now that a current is no longer supplied to the heating element 54, the protrusion 59 is reduced in size, ensuring the spacing greater than the reference value. This prevents the head 2 from colliding with the surface of the disk medium 1.

Instead of stopping the supply of power to the heating element 54, the power supplied to the element 54 may be decreased, thereby changing the spacing back to the reference value shown in FIG. 6A. This is because the data signal reproduced by the head 2 will change very much if the spacing is larger than the reference value, inevitably disabling stable data reading. If the data reading is unstable, in reproducing, for example, the servo data for controlling the positioning of the head 2, the head 2 cannot be positioned as is desired.

If the spacing is equal to or larger than the reference value (if NO in Block 129), the HDC 11 outputs a heater control signal 34 in response to an instruction from the CPU 13, decreasing the value of power supplied to the heating element 54 (Block 131). Nevertheless, it is not absolutely necessary to change the value of power supplied to the heating element 54 (in the ordinary control). It is desirable to provide a spacing equal to or larger than the reference value, thereby to prevent the head element unit 58 from colliding with the surface of the disk medium 1.

In each embodiment described above, the supply of power to the heating element 54 is stopped or the power supplied thereto is decreased if an impact due to a disturbance is detected to be applied to the disk drive, no matter whether the disk drive is writing or reading data in or from the disk medium, or the head is being positioned. The space between the head unit 58 and the disk medium 1 can be thereby increased, thus reliably preventing the head element unit 58 from colliding with the surface of the disk medium 1.

If the head 2 is writing data when an impact is detected to be applied to the disk drive, the data writing is interrupted immediately. This prevents unstable recording of data in the disk medium 1. Even if an impact is detected to be applied to the disk drive while the head 2 is reading data or being positioned, the data reading or the head positioning is continued.

When any impact is no longer applied to the disk drive, the power supplied to the heating element 54 is changed back to the initial preset value. Therefore, the spacing can become appropriate for enhancing the data-reading/writing efficiency.

In each embodiment, when an impact is detected to be applied to the disk drive, the heat the heating element 54 is generating is controlled, increasing the space between the head 2 and the disk medium 1. The head 2 can therefore be prevented from colliding with the disk medium 1. Hence, the spacing can be effectively controlled during both the data recording and the data reproducing, even if the disk drive receives an impact.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk drive comprising:
a head which includes a writing element for writing data in a disk medium and a reading element for reading data from the disk medium and which has a heating element for controlling a spacing between the head and the disk medium;
a power-supply control unit which is configured to control a supply of power to the heating element;
a shock sensor which is configured to detect an impact applied to the disk drive; and
a controller which is configured to control the power supplied to the heating element through the power-supply control unit, thereby increasing the spacing, when the shock sensor detects an impact applied to the disk drive while the head is writing data to record the data in the disk medium or reading data to reproduce the data from the disk medium.

2. The disk drive according to claim 1, wherein the controller causes the head to stop writing data and to keep reading data, when the shock sensor detects an impact applied to the disk drive.

3. The disk drive according to claim 1, wherein the controller causes the head to stop writing data and to keep reading data or moving toward a target position over the disk medium, when the shock sensor detects an impact applied to the disk drive.

4. The disk drive according to claim 1, wherein the controller includes comparing means for comparing the spacing with a reference value when the shock sensor detects an impact supplied to the disk drive, the spacing corresponding to the power supplied to the heating element, and the controller stops the supply of power to the heating element when the comparing means finds that the spacing is smaller than the reference value.

5. The disk drive according to claim 1, wherein the controller includes comparing means for comparing the spacing with a reference value when the shock sensor detects an impact supplied to the disk drive, the spacing corresponding to the power supplied to the heating element, and the controller decreases the power supplied to the heating element when the comparing means finds that the spacing is smaller than the reference value.

6. The disk drive according to claim 1, wherein the controller includes comparing means for comparing the spacing with a reference value when the shock sensor detects an impact supplied to the disk drive, the spacing corresponding to the power supplied to the heating element, and the controller maintains or decreases the power supplied to the heating element when the comparing means finds that the spacing is has exceeded the reference value.

7. The disk drive according to claim 1, wherein the controller causes the head to stop writing data and stops supplying power to the heating element when the shock sensor detects an impact applied to the disk drive, and the controller includes comparing means for comparing the spacing with a reference value when the shock sensor detects an impact supplied to the disk drive, while the head is performing an operation other than data writing, the spacing corresponding to the power supplied to the heating element, and the controller stops the supply of power to the heating element or decreases the power supplied to the heating element when the comparing means finds that the spacing is smaller than the reference value.

8. The disk drive according to claim 1, wherein the controller includes impact-determining means for determining the level of an impact applied to the disk drive and detected by the impact sensor and the controller stops supplying power to the heating element when the impact-determining means determines that the level of the impact is relatively high.

9. The disk drive according to claim 1, wherein the controller includes impact-determining means for determining the level of an impact applied to the disk drive and detected by the impact sensor, the controller causes the head to stop writing data and stops supplying power to the heating element when the shock sensor detects an impact applied to the disk drive, and the controller stops supplying power to the heating element while the head is performing an operation other than data writing, when the impact-determining means determines that the level of the impact is relatively high.

10. The disk drive according to claim 1, wherein the controller includes impact-determining means for determining the level of an impact applied to the disk drive and detected by the impact sensor, the controller causes the head to stop writing data and stops supplying power to the heating element when the shock sensor detects an impact applied to the disk drive, the controller includes comparing means for comparing the spacing with a reference value when the shock sensor detects a relatively high-level impact supplied to the disk drive, the spacing corresponding to the power supplied to the heating element, and the controller stops the supply of power to the heating element or decreases the power supplied to the heating element when the comparing means finds that spacing is smaller than the reference value.

11. A method of controlling a spacing in a disk drive that has a head including a writing element for writing data in a disk medium and a reading element for reading data from the disk-shaped element and a heating element for controlling the spacing between the head and the disk medium, a power-supply control unit configured to control a supply of power to the heating element, and a shock sensor configured to detect an impact applied to the disk drive, the method comprising:
detecting, by means of the shock sensor, the impact applied to the disk drive while the head is writing data to record the data in the disk-shaped medium or reading data to reproduce the data from the disk medium; and
controlling the power supplied to the heating element through the power-supply control unit, thereby increasing the spacing, when the shock sensor detects the impact applied to the disk drive.

12. The method according to claim 11, further comprising:
causing the head to stop writing data when the shock sensor detects an impact applied to the disk drive and to keep reading data, when the shock sensor detects an impact applied to the disk drive.

13. The method according to claim 11, further comprising:
comparing the spacing with a reference value when the shock sensor detects an impact supplied to the disk drive, the spacing corresponding to the power supplied to the heating element; and
stopping the supply of power to the heating element when the spacing is smaller than the reference value.

14. The method according to claim 11, further comprising:
causing the head to stop writing data and stopping the supply of power to the heating element when the shock sensor detects an impact applied to the disk drive;
comparing the spacing with a reference value when the shock sensor detects an impact supplied to the disk drive, while the head is performing an operation other than data writing, the spacing corresponding to the power supplied to the heating element; and
stopping the supply of power to the heating element or decreasing the power supplied to the heating element when the spacing is smaller than the reference value.
